(19) United States
(12) Patent Application Publication
(10) Pub. No.: US 2021/0165993 A1
(43) Pub. Date: Jun. 3, 2021

(54) NEURAL NETWORK TRAINING AND LINE OF SIGHT DETECTION METHODS AND APPARATUS, AND ELECTRONIC DEVICE

(71) Applicant: BEIJING SENSETIME TECHNOLOGY DEVELOPMENT CO., LTD., Beijing (CN)

(72) Inventors: Fei WANG, Beijing (CN); Shiyao HUANG, Beijing (CN); Chen QIAN, Beijing (CN)

(21) Appl. No.: 17/170,163

(22) Filed: Feb. 8, 2021

Related U.S. Application Data
(63) Continuation of application No. PCT/CN2019/093907, filed on Jun. 28, 2019.

(30) Foreign Application Priority Data
Sep. 29, 2018 (CN) 201811155648.0

(51) Int. Cl. G06K 9/00; G06T 7/73; G06F 3/01

(52) U.S. Cl. CPC G06K 9/0061; G06K 9/00604; G06T 7/73; G06T 2207/10016; G06T 2207/20081; G06T 2207/20084; G06F 3/013

(57) ABSTRACT

A neural network training method includes: determining first coordinates of a pupil reference point in a first image in a first camera coordinate system, and determining second coordinates of a cornea reference point in the first image in the first camera coordinate system, wherein the first image comprises at least an eye image; determining a first line-of-sight direction of the first image according to the first coordinates and the second coordinates; performing line-of-sight detection on the first image through the neural network to obtain a first detected line-of-sight direction; and training the neural network according to the first line-of-sight direction and the first detected line-of-sight direction.

### CROSS-REFERENCE TO RELATED APPLICATIONS

The present application is a continuation of International Application No. PCT/CN2019/093907, filed on Jun. 28, 2019, which claims priority to Chinese Patent Application No. 201811155648.0, filed on Sep. 29, 2018. The disclosures of International Application No. PCT/CN2019/093907 and Chinese Patent Application No. 201811155648.0 are thereby incorporated by reference in their entireties.

### BACKGROUND

Line-of-sight detection plays an important role in surveillance of drivers, human-computer interaction, security defense and monitoring. The line-of-sight detection is a technique of detecting a direction in which human eyes gaze in a three-dimensional (3D) space. In the field of the human-computer interaction, by determining 3D positions of a person's eyes in the space, in combination with the person's 3D line-of-sight direction, a position of a point is obtained on which the person's eyes gaze in the 3D space, and the position is outputted to a machine for further interaction processing.

### SUMMARY

The disclosure relates to the field of computer technology, and particularly to a method and device for training a neural network, a method and device for detecting a line of sight, an electronic device and a computer-readable storage medium.

A technical solution for training a neural network and a technical solution for detecting a line of sight are provided in the present application.

A first aspect according to the embodiments of the disclosure provides a method for training a neural network, the method including: determining first coordinates of a pupil reference point in a first image in a first camera coordinate system, and determining second coordinates of a cornea reference point in the first image in the first camera coordinate system, herein the first image comprises at least an eye image; determining a first line-of-sight direction of the first image according to the first coordinates and the second coordinates; performing line-of-sight detection on the first image through the neural network to obtain a first detected line-of-sight direction; and training the neural network according to the first line-of-sight direction and the first detected line-of-sight direction.

A second aspect according to the embodiments of the disclosure provides a method for detecting a line of sight, the method including: performing face detection on a second image included in video stream data; determining positions of key points in a face area in a detected second image to determine eye areas in the face area; clipping an eye-area image from the second image; and inputting the eye-area image into a neural network trained in advance using the method according to the first aspect, and outputting a line-of-sight direction of the eye-area image.

A third aspect according to the embodiments of the disclosure provides a device for training a neural network, the device including a memory storing processor-executable instructions, and a processor configured to execute the stored processor-executable instructions to perform operations of: determining first coordinates of a pupil reference point in a first image in a first camera coordinate system, and determining second coordinates of a cornea reference point in the first image in the first camera coordinate system, wherein the first image comprises at least an eye image; determining a first line-of-sight direction of the first image according to the first coordinates and the second coordinates; performing line-of-sight detection on the first image through the neural network to obtain a first detected line-of-sight direction; and training the neural network according to the first line-of-sight direction and the first detected line-of-sight direction.

A fourth aspect according to the embodiments of the disclosure further provides a non-transitory computer-readable storage medium having stored thereon instructions that, when run on a computer, cause the computer to perform the method described in the first aspect.

### BRIEF DESCRIPTION OF THE DRAWINGS

The accompanying drawings needed by the embodiments of the disclosure or the background are described below in order to make the technical solutions in the embodiments or the background described more clearly.

FIG. 1 is a schematic flowchart of a method for detecting a line of sight provided in an embodiment of the disclosure.

FIG. 2A is a schematic diagram of a scenario for key points on a face provided in an embodiment of the disclosure.

FIG. 2B is a schematic diagram of a scenario for an eye-area image provided in an embodiment of the disclosure.

FIG. 3 is a schematic flowchart of a method for training a neural network provided in an embodiment of the disclosure.

FIG. 4 is a schematic flowchart of a method for determining first coordinates provided in an embodiment of the disclosure.

FIG. 5 is a schematic flowchart of a method for determining second coordinates provided in an embodiment of the disclosure.

FIG. 6A is a schematic diagram of a first image provided in an embodiment of the disclosure.

FIG. 6B is a schematic diagram illustrating determination of a pupil reference point provided in an embodiment of the disclosure.

FIG. 6C is a schematic diagram illustrating determination of a cornea reference point provided in an embodiment of the disclosure.

FIG. 7 is a schematic diagram of a scenario of a method for training a neural network provided in an embodiment of the disclosure.

FIG. 8A is a schematic structural diagram of a device for training a neural network provided in an embodiment of the disclosure.

FIG. 8B is a schematic structural diagram of another device for training a neural network provided in an embodiment of the disclosure.

FIG. 9A is a schematic structural diagram of a first determining unit provided in an embodiment of the disclosure.

FIG. 9B is a schematic structural diagram of another first determining unit provided in an embodiment of the disclosure.

FIG. 10 is a schematic structural diagram of an electronic device provided in an embodiment of the disclosure.

FIG. 11 is a schematic structural diagram of a device for detecting a line of sight provided in an embodiment of the disclosure.

FIG. 12 is a schematic structural diagram of another device for detecting a line of sight provided in an embodiment of the disclosure.

FIG. 13 is a schematic structural diagram of an electronic device provided in an embodiment of the disclosure.

### DETAILED DESCRIPTION

The disclosure is described further in detail in combination with the accompanying drawings below in order to make purposes, technical solutions and advantages of the present application clearer.

Terms including “first” and “second” in the specification and claims of the present application as well as the accompanying drawing are not used to represent a specific order but make different objects distinguished from each other. In addition, terms “include”, “have” and their variations are intended to mean “include without excluding others”. For example, processes, methods, systems, products or devices that include some operations or units are not limited by listed operations or units but in some embodiments they further include operations or units that are not listed. Alternatively the processes, methods, systems, products or devices include other operations or units intrinsic to them.

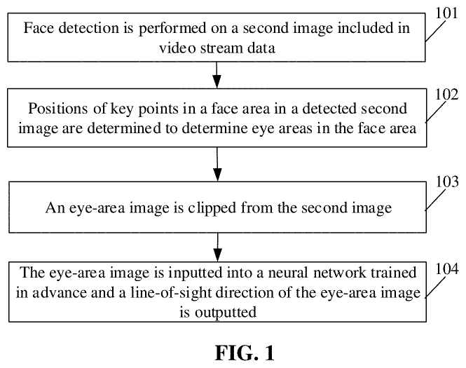

FIG. 1 is a schematic flowchart of a method for detecting a line of sight provided in an embodiment of the disclosure. The method for detecting the line of sight may be applied to a device for detecting the line of sight that may include a server and a terminal device. The terminal device may include a cellphone, a tablet computer, a desktop computer, a personal palmtop device, a vehicle-mounted device, a system for monitoring drivers' conditions, a television set, a game machine, a recreational device, an advertisement publishing device and the like. A detailed form of the device for detecting a line of sight is not limited to a unique form in the embodiment of the disclosure.

As illustrated in FIG. 1, the method for detecting the line of sight includes operations 101 to 104. In operation 101, face detection is performed on a second image included in video stream data.

In the embodiment of the disclosure, the second image may be any frame of image in the video stream data. Positions where faces in the second image are located may be known in the face detection. In some embodiments, when performing the face detection, the device for detecting a line of sight may have the detected human images included in a bounding box. The bounding box is, for example, in the shape of a square or a non-square rectangle, but the embodiment of the disclosure is not limited thereto.

In some embodiments, the video stream data may be data captured by the device for detecting the line of sight, data that is transmitted to the device for detecting a line of sight after captured by other devices, or the like. How the video stream data are obtained is not limited in the embodiment of the disclosure.

In some embodiments, the video stream data may be a video stream acquired by a vehicle-mounted camera for a driving area of the vehicle (i.e., a car, a truck, a tractor or a vehicle of any type). In other words, a line-of-sight direction outputted by operation 104, namely, a line-of-sight direction of the eye-area image, may be a line-of-sight direction of a driver in the driving area of the vehicle. It can be understood that the video stream data are data captured by the vehicle-mounted camera. The vehicle-mounted camera can be directly or indirectly connected to the device for detecting the line of sight. Which form that the vehicle-mounted camera takes is not limited in the embodiment of the disclosure.

The device for detecting the line of the sight may perform the face detection on the second image included in the video stream data of the driving area of the vehicle in real time or based on a preset frequency or based on a preset cycle, but the embodiment of the disclosure is not limited thereto. However, in order to further avoid power consumption of the device for detecting a line of sight and make the human detection more effective, the operation that the face detection is performed on the second image included in the video stream data includes following operations: in response to that a triggering instruction is received, the face detection is performed on the second image included in the video stream data; or in response to that the vehicle is traveling, the face detection is performed on the second image included in the video stream data; or in response to that a traveling speed of the vehicle reaches a reference speed, the face detection is performed on the second image included in the video stream data.

In the embodiment of the disclosure, the triggering instruction may be one that a user inputs into the device for detecting a line of sight or one transmitted by a terminal connected to the device for detecting the line of sight, or the like. Where the triggering instruction comes from is not limited in the embodiment of the disclosure.

In the embodiment of the disclosure, the fact that a vehicle is traveling can be understood as a fact that the vehicle starts to travel. In other words, when the device for detecting the line of the sight detects that the vehicle starts to travel, the device may perform the face detection on any frame of image (including the second image) in the obtained video stream data.

In the embodiment of the disclosure, the reference speed is a measure that is used to determine a minimum speed of the vehicle for the device for detecting a line of sight to perform the face detection on the second image included in the video stream data. Therefore, the value of the reference speed is not limited herein. The reference speed may be set by the user, or set by a device for measuring the traveling speed of the vehicle that is connected to the device for detecting a line of sight or set by the device for detecting the line of sight, but the embodiment of the disclosure is not limited thereto.

In operation 102, positions of key points in a face area in the detected second image are determined to determine eye areas in the face area.

In the embodiment of the disclosure, an algorithm such as the “robert” edge detection algorithm and the sobel algorithm, a relevant model such as the active contour snake model or the like may be used to determine the positions of the key points. Alternatively, a neural network used for detecting the key points on the face may be used to detect and output the key points. Furthermore, a third party application may be used to determine the positions of the key points on the face. For example a third party tool kit “dlib” is used to determine the positions of the key points on the face.

For example, “dlib” is a C++ open-source tool kit that is effective in determining the key points on the face and includes machine learning algorithms Δt present, the tool kit “dlib” is widely used in robots, embedded devices, mobile phones and a field of large high-performance computing environments. Therefore, the toolkit may be used effectively to obtain the key points on the face by determining their positions. In some embodiments, there may be 68 key points on the face. It can be understood: since each key point on the face has coordinates, namely pixel-point coordinates when its position is determined, the eye areas may be determined according to the coordinates of the key points. Alternatively, the detection may be performed on the key points on the face through the neural network to make key points 21, 106 or a key point 240 detected.

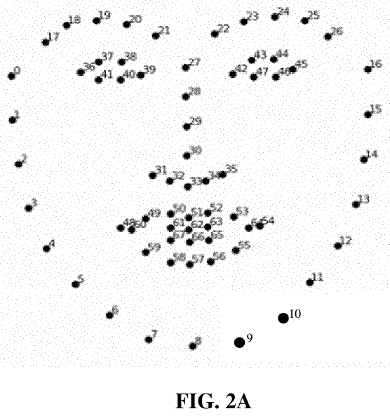

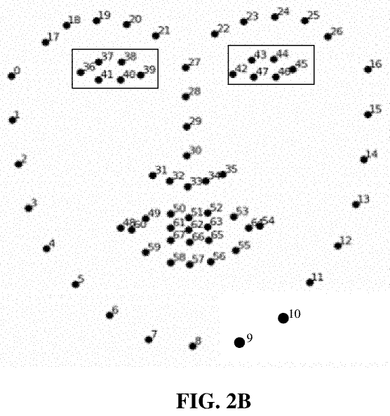

For example, FIG. 2A is a schematic diagram of a scenario for key points on a face provided in an embodiment of the disclosure. As illustrated in FIG. 2A, the key points on the face may include 68 key points: the key points 0-67. The eye areas including the key points 36 to 47 may be determined from among the 68 key points. Therefore, as illustrated in FIG. 2B, a left eye area may be determined according to the key points 36, 39, 37 (or 38), 40 (or 41) and a right eye area may be determined according to the key points 42, 45, 43 (or 44), 46 (or 47). In some embodiments, the eye areas may also be determined according to the key points 36, 45, 37 (or 38, or 43, or 44) and 41 (or 40, or 46, or 47).

It can be understood that the is an example of determining the eye areas provided in the embodiment of the disclosure. Other key points may be used to determine the eye areas in a detailed implementation of determination of the eye areas, but the embodiment of the disclosure is not limited thereto.

In operation 103, an eye-area image is clipped from the second image.

In the embodiment of the disclosure, after the eye areas on the face area are determined, the eye-area image may be clipped from the face area. With FIG. 2B taken as an example, the eye-area image is clipped based on two rectangle boxes illustrated in FIG. 2B.

It can be understood that the method used by the device for detecting a line of sight to clip the eye-area image is not limited in the embodiment of the disclosure. For example, the eye-area image may be clipped out by a picture clipping software, a drawing software or the like.

In operation 104, the eye-area image is inputted into a neural network trained in advance and a line-of-sight direction of the eye-area image is outputted.

In the embodiment of the disclosure, the device for training the neural network not only may automatically obtain first line-of-sight directions but also may accurately obtain a large number of first line-of-sight directions. Therefore, a large amount of accurate and reliable data are provided to train the neural network, which increases an efficiency of the training and accuracy in predicting the line-of-sight directions.

The neural network may be a Deep Neural Network (DNN), a Convolutional Neural Network (CNN) or the like. A form that the neural network takes is not limited in the embodiment of the disclosure.

In the embodiment of the disclosure, the neural network trained in advance may be a neural network trained by the device for detecting a line of sight or a neural network trained by other devices such as a device for training a neural network. After the training, the device for detecting a line of sight obtains the neural network from the device for training the neural network. During an implementation of the embodiment of the disclosure, an accuracy of line-of-sight detection on any frame of image in the video stream data may be increased effectively by the neural network that is trained in advance. Furthermore, the line-of-sight detection on any frame of image in the video stream data may enable the device for detecting a line of sight to make effective use of the line of sight to perform other operations.

In some embodiments, when the device for detecting a line of sight is a game machine, the device for detecting a line of sight may perform game interaction based on the line-of-sight detection, thereby increasing user satisfaction. When the device for detecting a line of sight is another household appliance such as a television set, the device for detecting a line of sight may wake up, sleep or perform other controlling operations based on the line-of-sight detection. For example, the device for detecting a line of sight may determine whether a user needs to turn on or turn off the household appliance such as the television set based on the line-of-sight direction, but the embodiment of the disclosure is not limited thereto. When the device for detecting a line of sight is a device for publishing advertisements, the device may publish the advertisements according to the line-of-sight detection. For example, the device determines contents of advertisements that users are interested in according to the outputted line-of-sight direction so that the device can publish the advertisements that the users are interested in.

It can be understood that what are described above are some examples that the device for detecting a line of sight provided in the embodiment of the disclosure performs other operations using the outputted line-of-sight direction. It is possible that other examples may be used on the detailed implementation. Therefore, the examples should not be understood as limitations to the embodiment of the disclosure.

It can be understood that when the line-of-sight detection is performed on the second image included in the video stream data, the line-of-sight direction outputted by the neural network may dither. Therefore, the method further includes a following operation: after the eye-area image is inputted into the neural network trained in advance and the line-of-sight direction of the eye-area image is outputted,

a line-of-sight direction of the second image is determined according to the line-of-sight direction of the eye-area image and a line-of-sight direction of at least one adjacent frame of image of the second image.

In the embodiment of the disclosure, the at least one adjacent frame of image may be understood as at least one frame of image that is adjacent to the second image. For example, the at least one frame of image may be M frames of images before the second image or N frames of images after the second image, where both M and N are integers greater than or equal to 1. For example, the second image is a 5th frame of image in the video stream data, then the device for detecting a line of sight may determine a line-of-sight direction of a 5th frame according to a line-of-sight direction of a 4th frame and the line-of-sight direction of the fifth frame.

In some embodiments, an average of the line-of-sight direction of the eye-area image and the line-of-sight direction of at least one adjacent frame of image of the second image may be determined as the line-of-sight direction of the second image, namely the line-of-sight direction of the eye-area image. The manner may effectively prevent the obtained line-of-sight direction from being determined as the line-of-sight direction predicted after the dither of the neural network and effectively make line-of-sight prediction more accurate.

For example, if the line-of-sight direction of the second image is (gx, gy, gz) n, the second image is an N-th frame of image in the video stream data, and line-of-sight directions corresponding to first N−1 frames of images are respectively (gx gy, gz) n−1, (gx gy, gz) n−2, . . . (gx gy, gz) 1, the line-of-sight direction of the N-th frame of image, namely the line-of-sight direction of the second image, may be calculated according to a formula (1):

$$gaze = \frac{1}{n} {{Σ}_{i = 1}^{n} ( gx , gy , gz )}_{i} . \qquad ( 1 )$$

In the formula (1), “gaze” is the line-of-sight direction of the second image, namely a 3D line-of-sight direction of the second image.

In some embodiments, the line-of-sight direction corresponding to the N-th frame of image may also be calculated according to a weighted sum of the line-of-sight direction corresponding to the N-th frame of image and the line-of-sight direction corresponding to the (N−1)th frame of image.

With the parameters shown above taken as another example, the line-of-sight direction corresponding to the N-th frame of image may be calculated according to a formula (2):

gaze=½Σᵢ₌ₙ₋₁ⁿ(gx,gy,gz)ᵢ (2).

It can be understand that the two formulas only constitute an example and should not be understood as a limitation on the embodiment of the disclosure.

Implementation of the embodiment of the disclosure may effectively prevent the line-of-sight direction outputted by the neural network from being subjected to the dither and make the line-of-sight prediction more accurate.

Based on what FIG. 1 illustrates, a method about how to make use of the line-of-sight direction outputted by the neural network is further provided in the embodiment of the disclosure. The method is shown below.

The method further includes following operations: after the line-of-sight direction of the eye-area image is outputted,

a region of interest (ROI) of the driver is determined according to the line-of-sight direction of the eye-area image;

a driving behavior of the driver is determined according to the ROI of the driver. The driving behavior includes whether the driver is driving distractedly.

In the embodiment of the disclosure, by outputting the line-of-sight direction, the device for detecting a line of sight can obtain a direction in which the driver gazes through analysis, that is to say, the device for detecting a line of sight can obtain an approximate region that the driver is interested in. Therefore, whether the driver is engrossed in driving may be determined according to the ROI. Normally, when driving attentively, the driver usually keeps looking ahead but occasionally looks sideways. But if it is found that the ROI is always not in front of him, it can be determined that the driver is driving distractedly.

In some embodiments, the device for detecting a line of sight can output early-warning prompt information when determining that the driver is driving distractedly. In order to make the early-warning prompt information outputted more accurately and spare the driver unnecessary troubles, the operation of outputting the early-warning prompt information may include following operations:

in response to that a number of times of distracted driving of the driver is less than a reference number of times, the early-warning prompt information is outputted;

alternatively, in response to that a length of time during which the driver is driving distractedly reaches a reference length of time, the early-warning prompt information is outputted; alternatively, in response to the length of time during which the driver is driving distractedly reaches the reference length of time and the number of times of distracted driving of the driver reaches the reference number of times, the early-warning prompt information is outputted; alternatively, in response to that the driver is driving distractedly, prompt information is transmitted to a terminal connected to the vehicle.

It can be understood that the reference number of times and the reference length of time are used to measure how the device for detecting a line of sight outputs the early-warning prompt information. Therefore, the reference number of times and the reference length of time are not specifically limited in the embodiment of the disclosure.

It can be understood that the device for detecting a line of sight may establish a wired or wireless connection with the terminal so that by transmitting the prompt information to the terminal, the device for detecting a line of sight can remind the driver or other people in the vehicle in time The terminal is a terminal of the driver or a terminal of another person in the vehicle. The terminal is not limited to a unique one in the embodiment of the disclosure.

Implementation of the embodiment of the disclosure may enable the device for detecting a line of sight to analyze the line-of-sight direction of any frame of image in the video stream data for many times or for a long time so that an accuracy in determining whether the driver is driving distractedly is further increased.

In some embodiments, in response to that the driver is driving distractedly, the device for detecting a line of sight may also store one or more of: the eye-area image, and a preset number of frames of images before and after the eye-area image; alternatively in response to that the driver is driving distractedly, the device for detecting a line of sight transmits, to the terminal connected to the vehicle, one or more of: the eye-area image, and a preset number of frames of images before and after the eye-area image.

In the embodiment of the disclosure, the device for detecting a line of sight may only store the eye-area image, or only store a preset number of frames of images before and after the eye-area image, or store both the eye-area image and the preset number of frames of images before and after the eye-area image, which makes it convenient for users to search for the line-of-sight direction afterwards. Transmission of the images to the terminal enables the users to query about the line-of-sight direction at any time and obtain at least one of: the eye-area image, or the preset number of frames of images before and after the eye-area image without delay.

The neural network in the embodiment of the disclosure can be designed by stacking network layers including a convolutional layer, a non-linear layer, and a pooling layer in a certain way. A detailed structure of the network is not limited in the embodiment of the disclosure. After the design of the structure of the neural network is finished, the designed neural network may be subjected to tens of thousands of iterative and supervised trainings using a method such as the back gradient propagation based on positive and negative sample images with labeled information. A detailed training manner is not limited in the embodiment of the disclosure. A method for training a neural network in some embodiments of the disclosure is introduced below.

Firstly, technical terms appearing in the embodiment of the disclosure are to be introduced below. A world coordinate system, namely a measurement coordinate system, is an absolute coordinate system. A camera coordinate system: an origin of the camera coordinate system is an optical center of a camera and a z-axis is an optical axis of the camera. A method of obtaining a relationship between the world coordinate system and the camera coordinate system is shown below: the world coordinate system including its original axis, x-axis, y-axis and z-axis is determined; and coordinates of any object in the world coordinate system may be obtained through measurement. For example, firstly coordinate systems of a group of points in the world coordinate system are obtained through the measurement and then the camera takes pictures of each point in the group to obtain a coordinate system of each point in the camera. If a 3*3 rotation matrix of the world coordinate system relative to the camera coordinate system is assumed to be R and a 3*1 translation vector of the world coordinate system relative to the camera coordinate system is assumed to be T, rotation and translation between the world coordinate system and the camera coordinate system may be obtained. It can be understood that the is only an example of obtaining the relationship between the world coordinate system and the camera coordinate system. Other manners may also be adopted to obtain the relationship in detailed implementation. Therefore, the method provided in the embodiment of the disclosure should not be used as a limitation.

The camera coordinate system: an origin of the camera coordinate system is the optical center of the camera and the z-axis is the optical axis of the camera. It can be understood the camera, also referred to as webcam, may be specifically a Red, Green and Blue (RGB) camera, an infrared camera, a near infrared camera or the like, but the embodiment of the disclosure is not limited thereto. In the embodiment of the disclosure, the camera coordinate system may also be referred to as webcam coordinate system, but the names are not limited herein. In the embodiment of the disclosure, the camera coordinate system includes a first camera coordinate system and a second coordinate system. A relationship between the first camera coordinate system and the second camera coordinate system is introduced in detail below.

The first camera coordinate system: in the embodiment of the disclosure, the first camera coordinate system is a coordinate system of any camera determined from among a camera array. It can be understood the camera array may also be referred to as a webcam array, which is not limited in the embodiment of the disclosure. Specifically, the first camera coordinate system may be a coordinate system corresponding to a first camera, or a coordinate system corresponding to a first webcam, and the like. The second camera coordinate system: in the embodiment of the disclosure, the second camera coordinate system is a coordinate system corresponding to a second camera, namely a coordinate system of the second camera. A method of determining the relationship between the first camera coordinate system and the second camera coordinate system is shown as follows: the first camera is determined from among the camera array and then the first camera coordinate system is determined; a focal length and a principal point position of each camera in the camera array are obtained; the relationship between the first camera coordinate system and the second camera coordinate system are determined according to the first camera coordinate system and the focal length and the principal point position of each camera in the camera array. For example, after the first camera coordinate system is set up, a classic checkerboard grid calibration method may be used to obtain the focal length and the principal point position of each camera in the camera array so that the rotation and the translation of other camera coordinate systems (such as the second camera coordinate system) relative to the first camera coordinate system are determined. In the embodiment of the disclosure, the camera array includes at least the first camera and the second camera, and the position and orientation of each camera relative to other cameras are not limited in the embodiment of the disclosure. For example, the relationships between each camera are set on condition that each camera in the camera array is able to cover the human eyes' line-of-sight range.

For example, cameras c1, c2, c3, c4, c5, c6, c7, c8, c9 and c10 constitute the camera array, c5 (that is a camera deployed in the center) is determined as the first camera and the first camera coordinate system is set up; the focal lengths f, the principal point positions (u, v) of all the cameras, and the rotation and translation of these cameras relative to the first camera are obtained using the classic checkerboard grid calibration method. A coordinate system in which each camera is located is defined as a camera coordinate system, and the positions and orientations of other cameras, relative to the first camera, in the first camera coordinate system are calibrated and calculated through a binocular camera; By doing this, the relationship between the first camera coordinate system and the second camera coordinate system can be determined. It can be understood that after the first camera is determined, the second camera may include other cameras other than the first camera and may include at least two cameras.

It can be understood that the is only an example and other methods such as the Zhengyou Zhang calibration method may be adopted to determine relationships between a reference camera coordinate system and other camera coordinate systems in detailed implementation, but the embodiment of the disclosure is not limited thereto. It may be understood the cameras in the embodiment of the disclosure may be infrared cameras or cameras of other types, but the embodiment of the disclosure is not limited thereto.

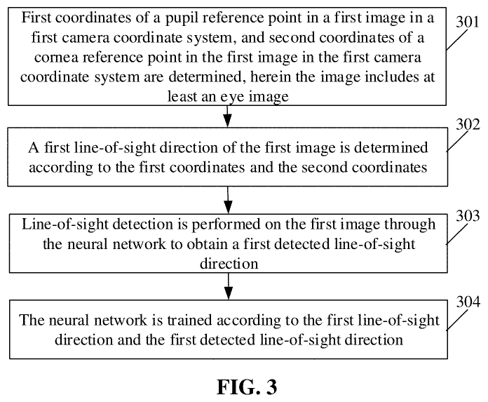

FIG. 3 is a schematic flowchart of a method for training a neural network provided in an embodiment of the disclosure. The method for training the neural network may be applied to a device for detecting a line of sight that may include a server and a terminal device. The terminal device may include a cellphone, a tablet computer, a desktop computer, a personal palmtop computer or the like. A specific form that the device for detecting a line of sight takes is not limited to a unique one in the embodiment of the disclosure. It can be understood that the method for training the neural network may also be applied to a device for training the neural network that may include a server and a terminal device. The type of the device for training the neural network may be same as or different from that of the device for detecting the line of sight, but the embodiment of the disclosure is not limited thereto.

As illustrated in FIG. 3, the method for training the neural network includes operations 301 to 304.

In operation 301, first coordinates of a pupil reference point in a first image in a first camera coordinate system, and second coordinates of a cornea reference point in the first image in the first camera coordinate system are determined. The first image includes at least an eye image.

In the embodiment of the disclosure, the first image is a two-dimensional (2D) picture that includes eyes and is captured by a camera. The first image is an image that is to be inputted into and train the neural network. Specifically, the first image may include at least two images and the number of the images that the first image includes is determined by progress of the training. Therefore, the number of the images that the first image includes is not limited in the embodiment of the disclosure.

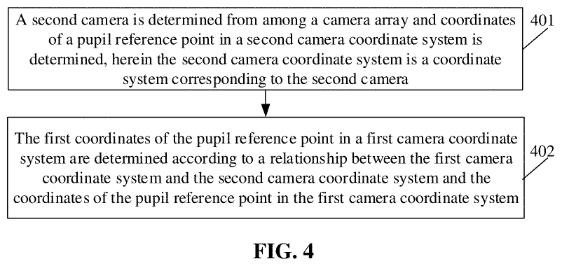

In the embodiment of the disclosure, if the camera that captures the first image is a second camera (including at least two cameras), the coordinates of the pupil reference point in the second camera coordinate system may be determined firstly and then the first coordinates are determined according to a relationship between the first camera coordinate system and a second camera coordinate system. Detailed implementation is illustrated in FIG. 4

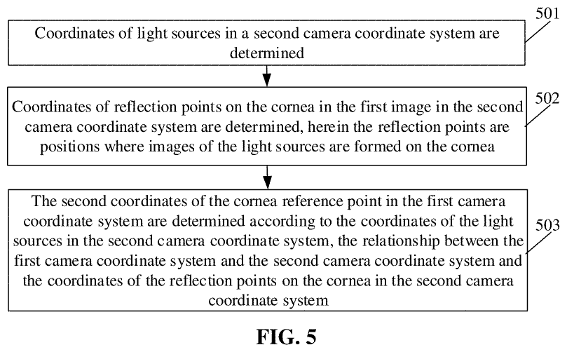

Likewise, positions where images of light sources are formed on the cornea reference point, namely coordinates of reflection points in the second camera coordinate system, may be determined firstly and then the second coordinates may be determined according to the relationship between the first camera coordinate system and the second camera coordinate system. Detailed implementation is illustrated in FIG. 5

In the embodiment of the disclosure, the cornea reference point may be any point on the cornea. In some embodiments, the cornea reference point may be a center of the cornea, a point on an edge of the cornea, or one of other key points on the cornea. The position of the cornea reference point is not limited to a unique position in the embodiment of the disclosure. The pupil reference point may also be any point on the pupil. In some embodiments, the pupil reference point may be a center of the pupil, a point on an edge of the pupil, or one of other key points on the pupil. The position of the pupil reference point is not limited to a unique position in the embodiment of the disclosure.

In operation 302, a first line-of-sight direction of the first image is determined according to the first coordinates and the second coordinates. In the embodiment of the disclosure, after the first coordinates and the second coordinates are obtained, the first line-of-sight direction may be obtained according to a line connecting the points respectively located at the two coordinates. That is to say, the determination of the first line-of-sight direction performed according to the connection between the pupil reference point and the cornea reference point may also make the first line-of-sight direction obtained more accurately.

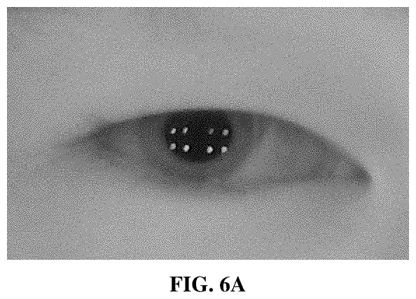

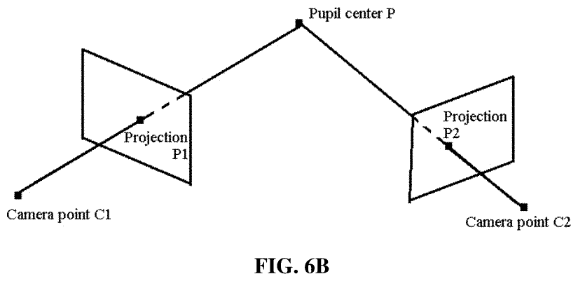

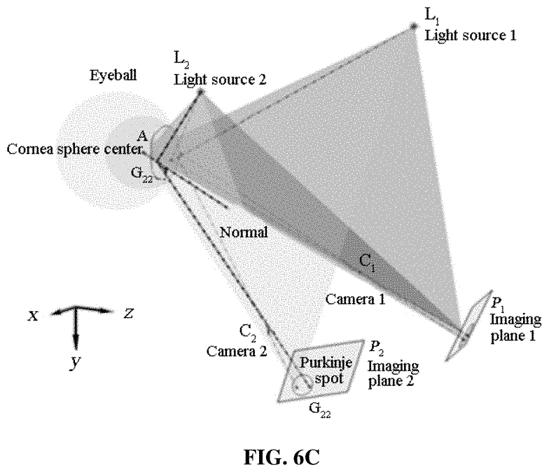

In operation 303, line-of-sight detection is performed on the first image through the neural network to obtain a first detected line-of-sight direction. It may be understood that the first image may also be an image that is only related to eyes so that other parts of a human body are prevented from increasing the workload of the neural network in the detection of the line-of-sight direction. FIG. 6A is a schematic diagram of a first image shown in an embodiment of the disclosure and also illustrates reflection points that light sources form on a cornea. It can be understood that the first image in the embodiment of the disclosure may be an image corresponding to an eye or an image corresponding to two eyes, but the embodiment of the disclosure is not limited thereto.

A method for obtaining the first image is further provided in the embodiment of the disclosure. The method for obtaining the first image is shown as follows: a position of a face in the image is obtained through a face detection method, herein a proportion of an area of the eyes in the image to an area of the image is greater than or equal to a preset proportion; positions of the eyes in the image are determined through key points on the face; and the image is clipped to obtain an image of the eyes from the former image. The image of the eyes is known as the first image.

In some embodiments, since the face is not upright due to rotation, after the positions of the eyes in the image are determined through the key points on the face, inner eye corners of the two eyes may be rotated so that the horizontal axis coordinates of the inner eye corners are equal. Therefore, the first image is finally obtained by clipping the eyes from the rotated image after the horizontal axis coordinates of the inner eye corners of the two eyes are made equal by the rotation.

It can be understood that the preset proportion is set to measure the proportion of the area of the eyes in the image and determine whether the obtained image needs clipping. The preset proportion may be set for other purposes. The value of the preset proportion value may be set by a user or automatically set by the device for training the neural network or set in other manners, but the embodiment of the disclosure is not limited thereto. For example, the image is exactly an image of eyes, in this case the image may be directly inputted into the neural network. For another example, the eyes take up one tenth of the image; in this case operations including the clipping need to be performed on the image to obtain the first image.

It can be understood that in order to further improve smoothness in a line-of-sight direction, the operation of performing the line-of-sight detection on the first image through the neural network to obtain the first detected line-of-sight direction includes following operations: in response to that the first image is a video image, a line-of-sight direction of each of N adjacent frames of images is detected through the neural network, herein N is an integer greater than 1; and a line-of-sight direction of an N-th frame of image is determined as the first detected line-of-sight direction according to the line-of-sight directions of the N adjacent frames of images.

In the embodiment of the disclosure, the value of N value is not limited. The N adjacent frames of images may be N frames of images (including the N-th frame of image) before the N-th frame of image, or N frames of images after the N-th frame of image, or a total of N frames of images before and after the N-th frame of image, but the embodiment of the disclosure is not limited thereto.

In some embodiments, the line-of-sight direction of the N-th frame of image is determined according to an average of the line-of-sight directions of the N adjacent frames of images and then smoothing processing is performed on the line-of-sight direction of the N-th frame of image so that the obtained first detected line-of-sight direction is more stable.

In operation 304, the neural network is trained according to the first line-of-sight direction and the first detected line-of-sight direction.

It can be understood that after the neural network is trained, a line-of-sight direction of a second image may be detected using the neural network. The implementation illustrated by FIG. 1 may be referred to for a detailed manner of the detection and details are not elaborated herein.

It can be understood that after the neural network is trained and obtained using the method, the device for training the neural network may directly apply the neural network to detect the line-of-sight direction or transmits the trained neural network to other devices so that these devices can use the trained neural network to detect the line-of-sight direction. The devices to which the trained neural network is transmitted by the device for training the neural network are not limited in the embodiment of the disclosure.

In some embodiment, the operation of training the neural network according to the first line-of-sight direction and the first detected line-of-sight direction includes a following operation:

one or more network parameters of the neural network are adjusted according to a loss between the first line-of-sight direction and the first detected line-of-sight direction.

In some embodiments, the method further includes a following operation: before the neural network is trained according to the first line-of-sight direction and the first detected line-of-sight direction,

normalization processing is respectively performed on the first line-of-sight direction and the first detected line-of-sight direction.

The operation of training the neural network according to the first line-of-sight direction and the first detected line-of-sight direction includes a following operation:

the neural network is trained according to the first line-of-sight direction subjected to the normalization processing and the first detected line-of-sight direction subjected to the normalization processing.

The one or more network parameters of the neural network may also be adjusted according to a loss between the first line-of-sight direction subjected to the normalization processing and the first detected line-of-sight direction subjected to the normalization processing. Specifically, the one or more network parameters may include a convolution kernel size parameter, a weighting parameter and the like. The one or more network parameters included by the neural network are not limited in the embodiment of the disclosure.

Specifically, if the first line-of-sight direction is assumed to be (x1, y1, z1) and the first detected line-of-sight direction is assumed to be (x2, y2, z2), a manner of the normalization processing may be shown as follows

$$\begin{matrix}normalize ground truth = ( \begin{matrix}\frac{( x 1 )}{\sqrt[2]{{( x 1 )}^{2} + {( y 1 )}^{2} + {( z 1 )}^{2}}} , \\ \frac{( y 1 )}{\sqrt[2]{{( x 1 )}^{2} + {( y 1 )}^{2} + {( z 1 )}^{2}}} , \\ \frac{( z 1 )}{\sqrt[2]{{( x 1 )}^{2} + {( y 1 )}^{2} + {( z 1 )}^{2}}}\end{matrix} ) . & ( 3 ) \\ normalize prediction gaze = ( \begin{matrix}\frac{( x 2 )}{\sqrt[2]{{( x 2 )}^{2} + {( y 2 )}^{2} + {( z 2 )}^{2}}} , \\ \frac{( y 2 )}{\sqrt[2]{{( x 2 )}^{2} + {( y 2 )}^{2} + {( z 2 )}^{2}}} , \\ \frac{( z 2 )}{\sqrt[2]{{( x 2 )}^{2} + {( y 2 )}^{2} + {( z 2 )}^{2}}}\end{matrix} ) . & ( 4 )\end{matrix}$$

In the above formulas, normalize ground truth is the first line-of-sight direction subjected to the normalization processing and normalize prediction gaze is the first detected line-of-sight direction subjected to the normalization processing.

A function for calculating the loss is shown as follows:

loss=∥normalize ground truth−normalize prediction gaze (5).

In the above formula, “loss” is the loss between the first line-of-sight direction subjected to the normalization processing and the first detected line-of-sight direction subjected to the normalization processing. It can be understood that a form that each of the letters takes or a form that each of the parameters takes is not a limitation on the embodiment of the disclosure but an example.

In the embodiment of the disclosure, the normalization processing on the first line-of-sight direction and the first detected line-of-sight direction may eliminate the negative impact of a vector length in the two directions so that attention is paid to the line-of-sight directions only.

In some embodiments, the loss between the first line-of-sight direction and the first detected line-of-sight direction may also be measured according to a cosine value of an angle between the first line-of-sight direction subjected to the normalization processing and the first detected line-of-sight direction subjected to the normalization processing. Specifically, the less the cosine value of the angle between the first line-of-sight direction subjected to the normalization processing and the first detected line-of-sight direction subjected to the normalization processing, the less the loss between the first line-of-sight direction and the first detected line-of-sight direction. In other words, as the angle between the first line-of-sight direction subjected to the normalization processing and the first detected line-of-sight direction subjected to the normalization processing increases, an Euclidean distance between a vector for the first line-of-sight direction and a vector for the first detected line-of-sight direction becomes longer and the loss between the two directions increases. When the two vectors completely overlap, the loss is equal to 0.

Implementation of the embodiment of the disclosure makes the device for training the neural network not only automatically obtains the first line-of-sight directions but also obtains a large number of first line-of-sight directions with accuracy. In this way, a large amount of accurate and reliable data is provided to train the neural network, which increases the accuracy in the training as well as the accuracy in detecting the line-of-sight directions.

A method about how to determine first coordinates is also provided in an embodiment of the disclosure. FIG. 4 is a schematic flowchart of a method for determining first coordinates according to the embodiment of the disclosure. The method may be applied to a device for training a neural network. As illustrated in FIG. 4, the method includes operations 401 to 402.

In operation 401, a second camera is determined from among a camera array and coordinates of a pupil reference point in a second camera coordinate system is determined. The second camera coordinate system is a coordinate system corresponding to the second camera.

In the embodiment of the disclosure, preceding embodiments may be referred to for detailed descriptions of the second camera coordinate system and the second camera; details are not elaborated herein.

In some embodiments, the operation of determining the coordinates of the pupil reference point in the second camera coordinate system includes following operations:

coordinates of the pupil reference point in the first image are determined;

the coordinates of the pupil reference point in the second camera system are determined according to the coordinates of the pupil reference point in the first image and a focal length and a principal point position of the second camera.

For example, the coordinates of the pupil reference point in the first image may be detected using a method for detecting edge points of the pupil. With a captured 2D eye picture, namely the first image, taken as an example, points surrounding the edge of the pupil of the eye may be extracted directly through a network model that detects the edge points of the pupil of the eye, and coordinates of the pupil reference points such as (m, n) are calculated according to the points surrounding the edge of the pupil. The calculated coordinates of the position of the pupil reference point: (m, n) may also be understood as the coordinates of the pupil reference point in the first image, or coordinates of the pupil reference point in a pixel coordinate system.

if it is assumed that the focal length of the camera that captures the first image (namely the second camera) is f and the principal point position of the camera is (u, v), coordinates of a point of the pupil reference point projected on an imaging plane of the second camera in the second camera coordinate system are (m-u, n-v, that are also 3D coordinates in the second camera coordinate system.

It can be understood that when the second camera includes at least two cameras, coordinates of a point of the pupil reference point projected on an imaging plane of each camera in the camera coordinate system of the camera are calculated according to the first image captured by different cameras (different cameras included by the second camera).

In operation 402, the first coordinates of the pupil reference point in a first camera coordinate system are determined according to a relationship between the first camera coordinate system and the second camera coordinate system and the coordinates of the pupil reference point in the first camera coordinate system.

It can be understood that in the embodiment of the disclosure, the second camera may be any camera in the camera array. In some embodiments, the second camera includes at least two cameras. In other words, at least two second cameras may be used to capture and obtain two first images; coordinates of the pupil in the second camera coordinate system of each camera in the second camera are obtained (the preceding description may be referred to for details); in this way, the coordinates in each second coordinate system may be converted into coordinates in the first camera coordinate system. Therefore, after the coordinates of the pupil in the first camera coordinate system and the coordinates of the pupil in the second camera coordinate system are determined in succession, coordinates of the pupil in a same coordinate system are obtained based on a fact that the camera, a projection point of the pupil reference point and the pupil reference point are on a same line. As illustrated in FIG. 6B, the coordinates of the pupil reference point (the one in FIG. 6B) in the first camera coordinate system is a common intersection point of these lines.

It can be understood that in some implementations the first camera coordinate system may also be referred to as a benchmark camera coordinate system or a reference camera coordinate system. Therefore, the name of the first camera coordinate system is not limited to a unique name in the embodiment of the disclosure.

Implementation of the embodiment of the disclosure may enable the coordinates of the pupil reference point in the first camera coordinate system obtained accurately, which lays a reliable foundation for determination of a first line-of-sight direction and increases an accuracy in training a neural network.

In some embodiments, a method about how to determine second coordinates is also provided in the embodiment of the disclosure. FIG. 5 is a schematic flowchart of a method for determining the second coordinates provided in an embodiment of the disclosure. The method may be applied to a device for training a neural network.

As illustrated in FIG. 5, the method includes operations 501 to 503.

In operation 501, coordinates of the light sources in a second camera coordinate system are determined.

In the embodiment of the disclosure, the light sources include infrared light sources, near-infrared light sources, non-infrared light sources or the like. Detailed types of the light sources are not limited in the embodiment of the disclosure.

In the embodiment of the disclosure, the light sources include at least two light sources. But in real applications, experiments show that use of only two light sources does not really produce a reliable result because: on one hand, too few light sources cannot eliminate interference of noises when equations are used to determine a cornea reference point; on the other hand, the light sources' lights reflected off the cornea may not be captured from some perspectives. Therefore, in the embodiment of the disclosure, the infrared light sources include at least three infrared light sources.

In some embodiments, the operation of determining the coordinates of the light sources in the second camera coordinate system includes following operations:

coordinates of the light sources in a world coordinate system are determined;

the coordinates of the light sources in the second camera coordinate system are determined according to a relationship between the world coordinate system and the second camera coordinate system.

The method of determining a relationship between the world coordinate system and the camera coordinate system may be referred to for the method of determining the relationship between the world coordinate system and the second camera coordinate system, which is no longer elaborated herein.

If it is assumed that there are eight infrared light sources: L1 to L8, their coordinates in the world coordinate system are {ai, i ranges from 1 to 8}, their coordinates in the second camera coordinate system are {bi, i ranges from 1 to 8}, a following formula is shown as follows:

ai=R×bi+T (6).

The preceding embodiments may be referred to for the method of obtaining R and T.

In operation 502, coordinates of reflection points on the cornea in the first image in the second camera coordinate system are determined. The reflection points are positions where images of the light sources are formed on the cornea.

In the embodiment of the disclosure, the reflection points are positions where images of light sources are formed on the cornea. As illustrated in FIG. 6A, the bright points in the eye are the reflection points. A number of the reflection points are same as that of the light sources.

The operation of determining the coordinates of the reflection points on the cornea in the first image in the second camera coordinate system is shown as follows:

coordinates of the reflection points in the first image are determined;

coordinates of the reflection points in the second camera coordinate system are determined according to the coordinates of the reflection points in the first image and a focal length and a principal point position of a second camera.

It can be understood that the implementation of determining the coordinates of the pupil reference point in the second camera coordinate system may be referred to for a detailed implementation of determining the coordinates of the reflection points on the cornea in the second camera coordinate system.

In operation 503, the second coordinates of the cornea reference point in the first camera coordinate system are determined according to the coordinates of the light sources in the second camera coordinate system, the relationship between the first camera coordinate system and the second camera coordinate system and the coordinates of the reflection points on the cornea in the second camera coordinate system.

In the embodiment of the disclosure, the second coordinates may be determined according to points at which the light sources, the reflection points and reflected lights intersect on an imaging plane. In other words, the second coordinates are determined according to incident lights, the reflected lights and a normal that are on a same plane. A detailed manner of determining the second coordinates is as follows.

The operation that the second coordinates of the cornea reference point in the first camera coordinate system are determined according to the coordinates of the light sources in the second camera coordinate system, the relationship between the first camera coordinate system and the second camera coordinate system and the coordinates of the reflection points on the cornea in the second camera coordinate system includes following operations:

coordinates of Purkinje spots respectively corresponding to the light sources in the second camera coordinate system are determined according to the coordinates of the infrared light sources in the second camera coordinate system and the coordinates of the reflection points on the cornea in the second camera coordinate system;

the second coordinates are determined according to the coordinates of the light sources in the second camera coordinate system, the coordinates of the reflection points on the cornea in the second camera coordinate system, the coordinates of the Purkinje spots in the second camera coordinate system and the relationship between the second camera coordinate system and the first camera coordinate system.

In order to make the method understood in a vivid way, a schematic diagram in FIG. 6C illustrates determination of a cornea reference point that is provided in an embodiment of the disclosure. L1 to L8 represent 8 infrared light sources.

For example, a light emitted by the infrared light source L2 reflected off a cornea and an image of L2 is formed in a camera C2. Specifically speaking, the light emitted by L2 reflects off G22 (a reflection point) on an outer surface of the cornea; the reflected light passes through C2 and intersects with an imaging plane P2 at a Purkinje spot G′22. According to the law of reflection, an incident light G22L2, the reflected light G′22C2 and a normal G22A are on a same plane. If the plane is denoted as π22=(L2−C2)×(G′22−C2), a center A of a sphere where the cornea is meets an equation: π22*(A−C2)=0. The first “2” in “π22” may represent a serial number of the infrared light source, and the second “2” in “π22” may represent a serial number of the camera. The meanings of the serial numbers in “π22” are similar to those of the serial numbers below.

Likewise, the other 3 planes including the sphere center A: π11, π12, π21 may be listed. Coordinates of A in the camera coordinate system may be obtained by solving the following equations:

π11*(A−C1)=0 (7)

π12*(A−C2)=0 (8)

π21*(A−C1)=0 (9)

π22*(A−C2)=0 (10).

As can be seen from the, although principles make it possible that the coordinates of the cornea reference point A in a reference camera coordinate system can be calculated using 3 of the 4 equations, it is found in practical data collection that use of only 2 light sources cannot produce a reliable result; the reason is that just a few equations cannot eliminate interference of noises and the light that is emitted by the light source and is reflected off the cornea cannot be captured. 8 infrared light sources in total are provided in an acquisition system in order to solve this problem, which ensures that enough bright reflection points used for calculating the coordinates of the cornea reference point are available on the cornea with most head postures and visual angles on tap.

During implementation of the embodiment of the disclosure to determine the cornea reference point, creation of an overdetermined set of equations using multiple spots may make improve robustness and an accuracy of calculation involved in the implementation. Therefore, the coordinates of the cornea reference point in the reference camera coordinate system may be obtained accurately, more accurate data are further provided to train a DNN with a greater efficiency.

It can be understood that the methods illustrated in FIG. 1 to FIG. 5 have their respective focuses. The description of other embodiments may be referred to for an implementation that is not described in detail in one embodiment.

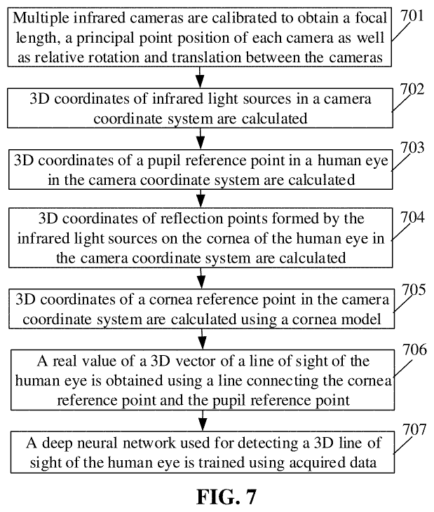

FIG. 7 is a schematic diagram of a scenario of a method for detecting a line of sight provided in an embodiment of the disclosure. The method includes operations 701 to 707.

In operation 701, multiple infrared cameras are calibrated to obtain a focal length, a principal point position of each camera as well as relative rotation and translation between the cameras.

In operation 702, 3D coordinates of infrared light sources in a camera coordinate system are calculated.

In operation 703, 3D coordinates (first coordinates) of a pupil reference point in a human eye (a human eye in a first image) in the camera coordinate system are calculated.

In operation 704, 3D coordinates of reflection points formed by the infrared light sources on the cornea of the human eye in the camera coordinate system are calculated.

In operation 705, 3D coordinates (second coordinates) of a cornea reference point in the camera coordinate system are calculated using a cornea model.

In operation 706, a real value of a 3D vector of a line of sight of the human eye is obtained using a line connecting the cornea reference point and the pupil reference point.

In operation 707, a neural network used for detecting the 3D line of sight of the human eye is trained using acquired data.

Implementation of the embodiment of the disclosure may make a large amount of line-of-sight data of the human eye (a first detected line-of-sight direction) and a real value of a corresponding line-of-sight direction (a first line-of-sight direction) obtained more quickly, accurately and steadily. An end-to-end manner makes a deep convolutional neural network used for detecting the 3D line of sight of the human eye easier to train. In addition, the trained network is applied more easily.

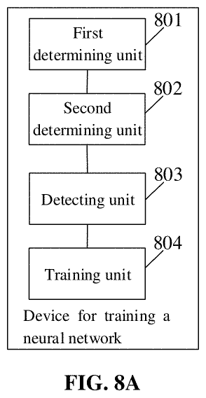

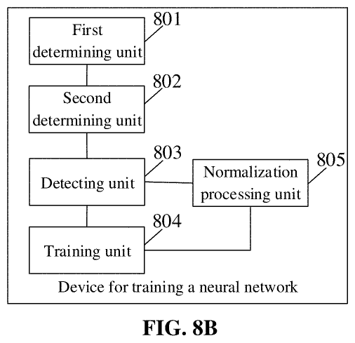

FIG. 8A is a schematic structural diagram of a device for training a neural network provided in an embodiment of the disclosure. The device for training the neural network may include a first determining unit 801, a second determining unit 802, a detecting unit 803 and a training unit 804.

The first determining unit 801 is configured to determine first coordinates of a pupil reference point in a first image in a first camera coordinate system, and determine second coordinates of a cornea reference point in the first image in the first camera coordinate system. The first image includes at least an eye image.

The second determining unit 802 is configured to determine a first line-of-sight direction of the first image according to the first coordinates and the second coordinates.

The detecting unit 803 is configured to perform line-of-sight detection on the first image through the neural network to obtain a first detected line-of-sight direction.

The training unit 804 is configured to train the neural network according to the first line-of-sight direction and the first detected line-of-sight direction.

Implementation of the embodiment of the disclosure makes the device for training the neural network not only automatically obtains the first line-of-sight directions but also obtains a large number of first line-of-sight directions with accuracy. In this way, a large amount of accurate and reliable data are provided to train the neural network, which increases an accuracy in the training as well as an accuracy in detecting or predicting the line-of-sight directions.

In some embodiments, the training unit 804 is specifically configured to adjust one or more network parameters of the neural network according to a loss between the first line-of-sight direction and the first detected line-of-sight direction.

In some embodiments, as illustrated in FIG. 8B, the device further includes a normalization processing unit.

The normalization processing unit is configured to perform normalization processing respectively on the first line-of-sight direction and the first detected line-of-sight direction.

The training unit is specifically configured to train the neural network according to the first line-of-sight direction subjected to the normalization processing and the first detected line-of-sight direction subjected to the normalization processing.

In some embodiments, the detecting unit 803 is specifically configured to detect a line-of-sight direction of each of N adjacent frames of images through the neural network in response to that the first image is a video image, herein N is an integer greater than 1; and determine, according to the line-of-sight directions of the N adjacent frames of images, a line-of-sight direction of an N-th frame of image as the first detected line-of-sight direction.

In some embodiments, the detecting unit 803 is specifically configured to determine, according to an average of the line-of-sight directions of the N adjacent frames of images, the line-of-sight direction of the N-th frame of image as the first detected line-of-sight direction.

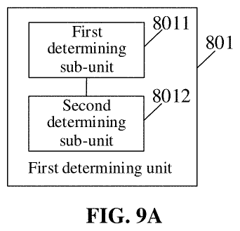

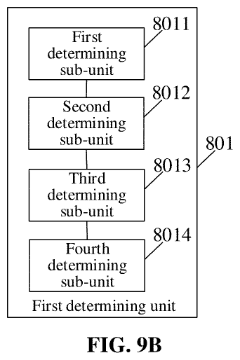

As illustrated in FIG. 9A, specifically, the first determining unit 801 includes a first determining sub-unit 8011 and a second determining sub-unit 8012.

The first determining sub-unit 8011 is configured to determine coordinates of the pupil reference point in a second camera coordinate system.

The second determining sub-unit 8012 is configured to determine, according to a relationship between the first camera coordinate system and the second camera coordinate system and the coordinates of the pupil reference point in the first camera coordinate system, the first coordinates of the pupil reference point in the first camera coordinate system.

In some embodiments, the first determining sub-unit 8011 is specifically configured to determine coordinates of the pupil reference point in the first image; and determine, according to the coordinates of the pupil reference point in the first image and a focal length and a principal point position of a second camera, the coordinates of the pupil reference point in the second camera system.

In some embodiments, as illustrated in FIG. 9B, the first determining unit 801 further includes a third determining sub-unit 8013 and a fourth determining sub-unit 8014.

The third determining sub-unit 8013 is configured to determine coordinates of reflection points on the cornea in the first image in the second camera coordinate system. The reflection points are positions where images of light sources are formed on the cornea.

The fourth determining sub-unit 8014 is configured to determine, according to the relationship between the first camera coordinate system and the second camera coordinate system and the coordinates of the reflection points on the cornea in the second camera coordinate system, the second coordinates of the cornea reference point in the first camera coordinate system.

In some embodiments, the fourth determining sub-unit 8014 is specifically configured to: determine coordinates of the light sources in the second camera coordinate system; and determine the second coordinates of the cornea reference point in the first camera coordinate system according to the coordinates of the light sources in the second camera coordinate system, the relationship between the first camera coordinate system and the second camera coordinate system and the coordinates of the reflection points on the cornea in the second camera coordinate system.

In some embodiments, the fourth determining sub-unit 8014 is specifically configured to: determine coordinates of Purkinje spots respectively corresponding to the light sources in the second camera coordinate system; and determine the second coordinates of the cornea reference point in the first camera coordinate system according to the coordinates of the Purkinje spots respectively corresponding to the light sources in the second camera coordinate system, the coordinates of the light sources in the second camera coordinate system, the relationship between the first camera coordinate system and the second camera coordinate system, and the coordinates of the reflection point on the cornea in the second camera coordinate system.

In some embodiments, the third determining sub-unit 8013 is specifically configured to: determine coordinates of the reflection points in the first image; and determine coordinates of the reflection points in the second camera coordinate system according to the coordinates of the reflection points in the first image and a focal length and a principal point position of above second camera.

In some embodiments, the fourth determining sub-unit 8014 is specifically configured to: determine coordinates of the light sources in a world coordinate system; and determine the coordinates of the light sources in the second camera coordinate system according to a relationship between the world coordinate system and the second camera coordinate system.

In some embodiments, the light sources include infrared light sources or near-infrared light sources, the light sources include at least two light sources, and a number of the reflection points corresponds to a number of the light sources.

It can be understood that the foregoing texts or corresponding descriptions of the method embodiments in FIG. 3 to FIG. 5 and FIG. 7 may also be referred to for implementation of each unit and device embodiments' technical effects.

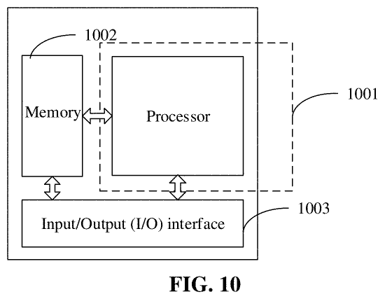

FIG. 10 is a schematic structural diagram of an electronic device provided in an embodiment of the disclosure. As illustrated in FIG. 10, the electronic device includes a processor 1001, a memory 1002, and an Input/Output (I/O) interface 1003. The processor 1001, the memory 1002 and the I/O interface 1003 connect to each other through a bus.

Data and/or signals may be inputted into the I/O interface 1003 and the I/O interface 1003 may be configured to output the data and/or the signals. For example, after the electronic device finishes training a neural network, the I/O interface 1003 may be configured to transmit the trained neural network to other electronic devices.

The memory 1002 includes but is not limited to a Random Access Memory (RAM), a Read-Only Memory (ROM), an Erasable Programmable Read Only Memory (EPROM), a Compact Disc Read-Only Memory (CD-ROM) and is configured to store relevant instructions and data. The memory 1002 is configured to store relevant instructions and data.

The processor 1001 may be one or more Central Processing Units (CPUs). When the processor 1001 is a CPU, it may be a single-core CPU or a multi-core CPU.

In some embodiments, corresponding descriptions of the method embodiments illustrated in FIG. 3 to FIG. 5 and FIG. 7 or the device embodiments illustrated in FIG. 8A, FIG. 8B, FIG. 9A, FIG. 9B may be also referred to for implementation of each operation.

For example, in an embodiment, the processor 1001 may be configured to perform the methods described in operation 301, operation 302, operation 303 and operation 304. For another example, the processor 1001 may also be configured to perform the methods performed by the first determining unit 802, the second determining unit 802, the detecting unit 803 and the training unit 804.

It can be understood that other embodiments may also be referred to for the implementation of each operation, which is not elaborated herein.

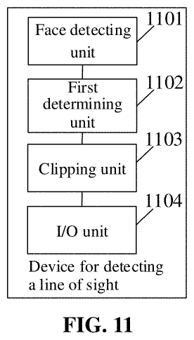

FIG. 11 is a schematic structural diagram of a device for detecting a line of sight provided in an embodiment of the disclosure. The device for detecting a line of sight may be configured to perform the method illustrated in FIG. 1 to FIG. 7. As illustrated in FIG. 11, the device for detecting a line of sight includes a face detecting unit 1101, a first determining unit 1102, a clipping unit 1103 and an inputting and outputting unit 1104.

The face detecting unit 1101 is configured to perform face detection on a second image included in video stream data.

The first determining unit 1102 is configured to determine positions of key points in a face area in the detected second image to determine eye areas in the face area.

The clipping unit 1103 is configured to clip an eye-area image from the second image.

The inputting and outputting unit 1104 is configured to input the eye-area image into a neural network trained in advance and output a line-of-sight direction of the eye-area image.

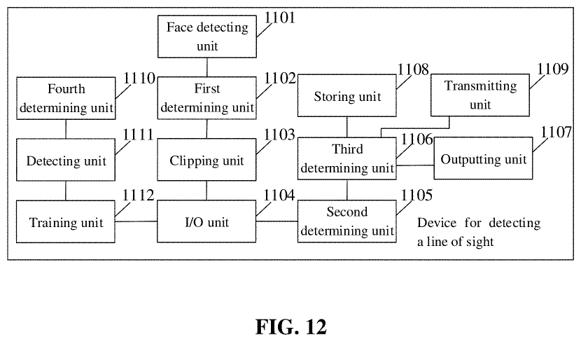

In some embodiments, as illustrated in FIG. 12, the device for detecting a line of sight further includes a second determining unit 1105.

The second determining unit 1105 is configured to determine a line-of-sight direction of the second image according to the line-of-sight direction of the eye-area image and a line-of-sight direction of at least one adjacent frame of image in above the second image.

In some embodiments, the face detecting unit 1101 is specifically configured to perform the face detection on the second image included in the video stream data in response to that a triggering instruction is received.

Alternatively, the face detecting unit 1101 is specifically configured to, in response to that a vehicle is traveling, perform the face detection on the second image included in the video stream data.

Alternatively, the face detecting unit 1101 is specifically configured to, in response to that a traveling speed of the vehicle reaches a reference speed, perform the face detection on the second image included in the video stream.

In some embodiments, the video stream data is a video stream acquired by a vehicle-mounted camera for an driving area of the vehicle; and

the line-of-sight direction of the eye-area image is a line-of-sight direction of a driver in the driving area of the vehicle.

In some embodiments, as illustrated in FIG. 12, the device further includes a third determining unit 1106.

The third determining unit 1106 is configured to: determine an area interesting the driver according to the line-of-sight direction of the eye-area image; and determine a driving behavior of the driver according to the area interesting the driver. The driving behavior includes whether the driver is driving distractedly.

In some embodiments, as illustrated in FIG. 12, the device further includes an outputting unit 1107.

The outputting unit 1107 is configured to output early-warning prompt information in response to that the driver is driving distractedly.

In some embodiments, the outputting unit 1107 is specifically configured to output the early-warning prompt information in response to that a number of times the driver is driving distractedly is less than a reference number of times;

alternatively, the outputting unit 1107 is specifically configured to output the early-warning prompt information in response to that a length of time during which the driver is driving distractedly reaches a reference length of time;

alternatively, the outputting unit 1107 is specifically configured to output the early-warning prompt information in response to the length of time during which the driver is driving distractedly reaches the reference length of time and the number of times the driver is driving distractedly reaches the reference number of times;

alternatively, the outputting unit 1107 is specifically configured to transmit prompt information to a terminal connected to the vehicle in response to that the driver is driving distractedly.

As illustrated in FIG. 12, the device further includes a storing unit 1108 or a transmitting unit 1109.

The storing unit 1108 is specifically configured to, in response to that the driver is driving distractedly, store one or more of: the eye-area image, and a preset number of frames of images before and after the eye-area image.

The transmitting unit 1109 is configured to, in response to that the driver is driving distractedly, transmit, to the terminal connected to the vehicle, one or more of: the eye-area image, and a preset number of frames of images before and after the eye-area image.

In some embodiments, as illustrated in FIG. 12, the device further includes a fourth determining unit 1110, a detecting unit 1111 and a training unit 1112.

The fourth determining unit 1110 is configured to determine a first line-of-sight direction according to a first camera and a pupil in a first image. The first camera is a camera that captures the first image. The first image includes at least an eye image.

The detecting unit 1111 is configured to detect a line-of-sight direction of the first image through a neural network to obtain a first detected line-of-sight direction.

The training unit 1112 is configured to train the neural network according to the first line-of-sight direction and the first detected line-of-sight direction.

It should be noted that in some embodiments, the foregoing texts and the relevant descriptions of the method embodiments illustrated by FIG. 1 to FIG. 7 may be referred to for implementation of each unit and device embodiments' technical effects.

It can be understood that the detailed implementations illustrated by FIG. 8A and FIG. 8B may be referred to for specific implementations of the fourth determining unit, the detecting unit and the training unit.

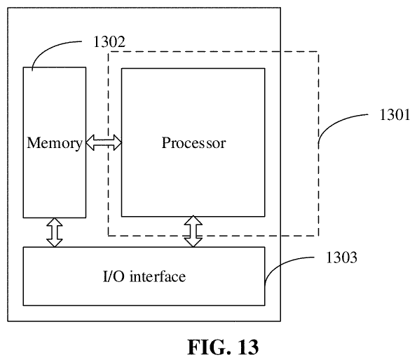

FIG. 13 is a schematic structural diagram of an electronic device provided in an embodiment the disclosure. As illustrated in FIG. 13, the electronic device includes a processor 1301, a memory 1302 and an I/O interface 1303 that are interconnected with each other through a bus.

Data and/or signals may be inputted into the I/O interface 1303 and the I/O interface 1303 may output the data and/or the signal.

The memory 1302 includes but is not limited to an RAM, an ROM, an EPROM, and a CD-ROM. The memory 1302 is configured to store relevant instructions and data.

The processor 1301 may be one or more CPUs. When the processor 1301 is a CPU, it may be a single-core CPU or a multi-core CPU.

In some embodiments, corresponding descriptions of the method embodiments illustrated in FIG. 1 to FIG. 7 or the method embodiments illustrated in FIG. 11 and FIG. 12 may be also referred to for implementation of each operation.

For example, in an embodiment, the processor 1301 may be configured to perform the method shown by operations 101 to 104. For another example, the processor 1301 may be also configured to perform the method that is performed by the face detection unit 1101, the first determining unit 1102, the clipping unit 1103 and the I/O unit 1104. It should be understood that each operation may be implemented with reference to other embodiments, which will not be elaborated herein.

In some embodiments provided by the disclosure, it is to be understood that the disclosed system, device and method may be implemented in another manner. For example, the units are only divided according to logic functions, and may also be divided in other manner during practical implementation. For example, multiple units or components may be combined or integrated into another system, or some characteristics may be omitted or not executed. In addition, displayed or discussed coupling or direct coupling or communication connection may be indirect coupling or communication connection between the devices or the units through some interfaces, and may be electrical and mechanical or in other forms.

The units described as separate parts may or may not be physically separated, and parts displayed as units may or may not be physical units, that is, may be located in the same place, or may also be distributed across multiple network units. A part or all of the units may be selected to achieve the purpose of the solutions of the embodiments according to a practical requirement.

It can be understood by those of ordinary skills in the art that a computer program may instruct relevant hardware to implement the whole or parts of the process of the method in the embodiments. The program is stored in a computer-readable storage medium. When the program is executed, it can include something such as a process of each of the method embodiments. The foregoing storage medium includes a medium capable of storing program codes such as an ROM, an RAM, a magnetic disk and an optical disk.

1. A method for training a neural network, comprising:
determining first coordinates of a pupil reference point in a first image in a first camera coordinate system, and determining second coordinates of a cornea reference point in the first image in the first camera coordinate system, wherein the first image comprises at least an eye image;
determining a first line-of-sight direction of the first image according to the first coordinates and the second coordinates;
performing line-of-sight detection on the first image through the neural network to obtain a first detected line-of-sight direction; and
training the neural network according to the first line-of-sight direction and the first detected line-of-sight direction.

2. The method of claim 1, wherein training the neural network according to the first line-of-sight direction and the first detected line-of-sight direction comprises:
adjusting one or more network parameters of the neural network according to a loss between the first line-of-sight direction and the first detected line-of-sight direction.

3. The method of claim 1, further comprising: before training the neural network according to the first line-of-sight direction and the first detected line-of-sight direction,
performing normalization processing respectively on the first line-of-sight direction and the first detected line-of-sight direction,
wherein training the neural network according to the first line-of-sight direction and the first detected line-of-sight direction comprises:
training the neural network according to the first line-of-sight direction subjected to the normalization processing and the first detected line-of-sight direction subjected to the normalization processing.

4. The method of claim 1, wherein performing the line-of-sight detection on the first image through the neural network to obtain the first detected line-of-sight direction comprises:
in response to that the first image is a video image, detecting a line-of-sight direction of each of N adjacent frames of images through the neural network, wherein N is an integer greater than 1; and
determining, according to the line-of-sight directions of the N adjacent frames of images, a line-of-sight direction of an N-th frame of image as the first detected line-of-sight direction.

5. The method of claim 4, wherein determining, according to the line-of-sight directions of the N adjacent frames of images, the line-of-sight direction of the N-th frame of image as the first detected line-of-sight direction comprises:
determining, according to an average of the line-of-sight directions of the N adjacent frames of images, the line-of-sight direction of the N-th frame of image as the first detected line-of-sight direction.

6. The method of claim 1, wherein determining the first coordinates of the pupil reference point in the first image in the first camera coordinate system comprises:
determining coordinates of the pupil reference point in a second camera coordinate system; and
determining, according to a relationship between the first camera coordinate system and the second camera coordinate system and the coordinates of the pupil reference point in the first camera coordinate system, the first coordinates of the pupil reference point in the first camera coordinate system.

7. The method of claim 6, wherein determining the coordinates of the pupil reference point in the second camera coordinate system comprises:
determining coordinates of the pupil reference point in the first image; and
determining, according to the coordinates of the pupil reference point in the first image and a focal length and a principal point position of a second camera, the coordinates of the pupil reference point in the second camera coordinate system.

8. The method of claim 1, wherein determining the second coordinates of the cornea reference point in the first image in the first camera coordinate system comprises:
determining coordinates of reflection points on the cornea in the first image in a second camera coordinate system, wherein the reflection points are positions where images of light sources are formed on the cornea; and
determining, according to the relationship between the first camera coordinate system and the second camera coordinate system and the coordinates of the reflection points on the cornea in the second camera coordinate system, the second coordinates of the cornea reference point in the first camera coordinate system.

9. The method of claim 8, wherein determining, according to the relationship between the first camera coordinate system and the second camera coordinate system and the coordinates of the reflection points on the cornea in the second camera coordinate system, the second coordinates of the cornea reference point in the first camera coordinate system comprises:
determining coordinates of the light sources in the second camera coordinate system; and
determining the second coordinates of the cornea reference point in the first camera coordinate system according to the coordinates of the light sources in the second camera coordinate system, the relationship between the first camera coordinate system and the second camera coordinate system and the coordinates of the reflection points on the cornea in the second camera coordinate system.

10. The method of claim 9, determining the second coordinates of the cornea reference point in the first camera coordinate system according to the coordinates of the light sources in the second camera coordinate system, the relationship between the first camera coordinate system and the second camera coordinate system and the coordinates of the reflection points on the cornea in the second camera coordinate system comprises:
determining coordinates of Purkinje spots respectively corresponding to the light sources in the second camera coordinate system; and
determining the second coordinates of the cornea reference point in the first camera coordinate system according to the coordinates of the Purkinje spots respectively corresponding to the light sources in the second camera coordinate system, the coordinates of the light sources in the second camera coordinate system, the relationship between the first camera coordinate system and the second camera coordinate system, and the coordinates of the reflection point on the cornea in the second camera coordinate system.

11. The method of claim 8, wherein determining the coordinates of the reflection points on the cornea in the first image in the second camera coordinate system comprises:
determining coordinates of the reflection points in the first image; and
determining coordinates of the reflection points in the second camera coordinate system according to the coordinates of the reflection points in the first image and a focal length and a principal point position of a second camera.

12. The method of claim 9, wherein determining the coordinates of the light sources in the second camera coordinate system comprises:
determining coordinates of the light sources in a world coordinate system; and
determining the coordinates of the light sources in the second camera coordinate system according to a relationship between the world coordinate system and the second camera coordinate system.

13. The method of claim 8, wherein the light sources comprise infrared light sources or near-infrared light sources, the light sources comprise at least two light sources, and a number of the reflection points corresponds to a number of the light sources.

14. A method for detecting a line of sight, comprising:
performing face detection on a second image comprised in video stream data;
determining positions of key points in a face area in a detected second image to determine eye areas in the face area;
clipping an eye-area image from the second image; and
inputting the eye-area image into a neural network trained in advance using the method of claim 1, and outputting a line-of-sight direction of the eye-area image.

15. A device for training a neural network, comprising:
a memory storing processor-executable instructions; and
a processor configured to execute the stored processor-executable instructions to perform operations of:
determining first coordinates of a pupil reference point in a first image in a first camera coordinate system, and determining second coordinates of a cornea reference point in the first image in the first camera coordinate system, wherein the first image comprises at least an eye image;
determining a first line-of-sight direction of the first image according to the first coordinates and the second coordinates;
performing line-of-sight detection on the first image through the neural network to obtain a first detected line-of-sight direction; and
training the neural network according to the first line-of-sight direction and the first detected line-of-sight direction.

16. The device of claim 15, wherein training the neural network according to the first line-of-sight direction and the first detected line-of-sight direction comprises:
adjusting one or more network parameters of the neural network according to a loss between the first line-of-sight direction and the first detected line-of-sight direction.

17. The device of claim 15, wherein before training the neural network according to the first line-of-sight direction and the first detected line-of-sight direction, the processor is configured to execute the stored processor-executable instructions to further perform an operation of:
performing normalization processing respectively on the first line-of-sight direction and the first detected line-of-sight direction,
wherein training the neural network according to the first line-of-sight direction and the first detected line-of-sight direction comprises:
training the neural network according to the first line-of-sight direction subjected to the normalization processing and the first detected line-of-sight direction subjected to the normalization processing.

18. The device of claim 15, wherein performing the line-of-sight detection on the first image through the neural network to obtain the first detected line-of-sight direction comprises:
in response to that the first image is a video image, detecting a line-of-sight direction of each of N adjacent frames of images through the neural network, wherein N is an integer greater than 1; and
determining, according to the line-of-sight directions of the N adjacent frames of images, a line-of-sight direction of an N-th frame of image as the first detected line-of-sight direction.

19. The device of claim 18, wherein determining, according to the line-of-sight directions of the N adjacent frames of images, the line-of-sight direction of the N-th frame of image as the first detected line-of-sight direction comprises:
determining, according to an average of the line-of-sight directions of the N adjacent frames of images, the line-of-sight direction of the N-th frame of image as the first detected line-of-sight direction.

20. A non-transitory computer-readable storage medium having stored thereon program instructions that, when executed by a processor, cause the processor to perform the method of claim 1.
